(19) United States
(12) Patent Application Publication
(10) Pub. No.: US 2024/0085381 A1
(43) Pub. Date: Mar. 14, 2024

(54) COMPACT, PORTABLE PHASED ARRAY SCANNING HOUSING

(71) Applicant: Verifi Technologies, LLC, Waco, TX (US)

(72) Inventors: Benjamin M. Blandford, Waco, TX (US); Nathaniel J. Blackman, Hewitt, TX (US); Gary Georgeson, Tacoma, WA (US)

(73) Assignee: Verifi Technologies, LLC, Waco, TX (US)

(21) Appl. No.: 18/244,572

(22) Filed: Sep. 11, 2023

Related U.S. Application Data
(60) Provisional application No. 63/375,321, filed on Sep. 12, 2022.

(51) Int. Cl. G01N 29/26; G01N 29/04; G01N 29/22; G01N 29/28

(52) U.S. Cl. CPC G01N 29/262; G01N 29/04; G01N 29/226; G01N 29/28; G01N 2291/0289; G01N 2291/106

(57) ABSTRACT

A phased array housing device includes a transducer housing section, including a linear phased array of transducer elements, and a couplant housing section, including one or more couplants. The linear phased array is able to translate across the length of the transducer housing section to simulate the results of a two-dimensional matrix of transducer elements. Some versions of the linear phased array attach to a pivot point after reaching an end of the transducer housing section such that the linear phased array is able to rotate and scan in a second direction.

### CROSS-REFERENCE TO RELATED APPLICATIONS

This application is related to and claims priority from the following US patents and patent applications: this application claims priority from and the benefit of U.S. Provisional Patent Application No. 63/375,321, filed Sep. 12, 2022, which is incorporated herein by reference in its entirety.

### BACKGROUND OF THE INVENTION

### 1. Field of the Invention

The present invention relates to phased array ultrasonic testing devices, and more specifically to housings for linear phased arrays for simulating a two dimensional (2D) matrix of transducer elements having a high density of transducer array elements.

### 2. Description of the Prior Art

It is generally known in the prior art to provide phased array ultrasonic testing systems, which are formed from arrays of individual ultrasonic transducers, to nondestructively scan test objects to identify flaws, features, or qualities of the test objects. By applying different focal laws, or rules for timing the firing of each individual transducer in the array, an ultrasonic beam produced by the phased array is able to be angled or focused at different depths.

Prior art devices have placed phased array elements within roller probes, such as the ROLLERFORM produced by Olympus. Alternatively, phased array systems have been used to scan parts within immersion tanks.

Prior art patent documents include the following:

U.S. Pat. No. 7,021,143 for Cylindrically-Rotating Ultrasonic Phased Array Inspection Method For Resistance Spot Welds by inventor Dasch, filed Dec. 11, 2003 and issued Apr. 4, 2006, discloses an ultrasonic inspection assembly having an ultrasonic transducer mounted on a stage, with a support structure below. The support structure is coupled to the stage, and the support structure has an interior space filled with a couplant media. The transducer is oriented such that it transmits ultrasonic waves through the media. A drive mechanism rotates one of the stage and the support structure relative to the other one of the stage and the support structure.

U.S. Pat. No. 8,475,384 for Three dimensional imaging ultrasound probe by inventors Hart et al., filed Jul. 22, 2009 and issued Jul. 2, 2013, discloses an ultrasound probe including a transducer array which is moved back and forth to sweep the image plane of the array through a volumetric region for 3D scanning. The transducer array is mounted on a carriage assembly which moves back and forth on a pair of rails inside a fluid compartment in the probe. The rails are preferentially arcuately curved to provide an elevationally divergent scan with a relatively wide aperture in the near field. A cam is provided for a motor-driven cable drive for the carriage assembly which provides relatively linear motion through the path of travel of the transducer array.

US Patent Publication No. 2019/0250128 for Variable Radius Inspection Using Sweeping Linear Array by inventors Motzer et al., filed Apr. 19, 2019 and published Aug. 15, 2019, discloses a method and apparatus for enabling ultrasonic inspection of a changing, insufficiently defined or unknown shape (e.g., a variable radius or a noncircular radius caused by the use of soft tooling) at a rate that meets production requirements. The apparatus comprises a linear ultrasonic array (i.e., sensor) incorporated in a toppler, which in turn is slidably supported by an oscillating sensor mechanism carried by a traveling trailer vehicle. As a result of this arrangement, the sensor can undergo a back-and-forth sweeping motion coupled with motion along the spar radius. The sensor is further able to displace radially relative to a sweep pivot axis and rotate (hereinafter “topple”) about a topple pivot axis. In this manner, the orientation of the sensor can adjust to the contour of the inspected surface as the sensor scans.

U.S. Pat. No. 10,458,960 for Integrated system for quantitative real-time monitoring of hydrogen-induced cracking in simulated sour environment by inventors Traidia et al., filed Dec. 3, 2018 and issued Oct. 29, 2019, discloses a method and system for monitoring hydrogen-induced cracking in at least one test specimen. The method includes the steps of: saturating a test solution with a gas comprising H25 and delivering the saturated test solution into a test cell, wherein the test cell comprises at least one specimen port and at least one test specimen. The specimen port is configured to receive the test specimen. The method also includes the step of exposing the at least one test specimen to the saturated test solution, wherein only one surface of each specimen is exposed to the saturated test solution and the step of scanning the test specimen with a ultrasonic transducer at two or more time points, wherein the ultrasonic transducer is operatively connected to the specimen port and configured to rotate completely around the symmetry axis of the test specimen to complete each scan.

US Patent Publication No. 2007/0066901 for Fluid driven mechanical scanning with an ultrasound transducer array by inventors Hansen et al., filed Sep. 22, 2005 and published Mar. 22, 2007, discloses a wobbler drive mechanism for mechanically scanning an ultrasound transducer array. A fluid drive moves the transducer array. A pump causes fluid flow. The fluid flow transfers energy to the transducer array for moving the transducer array.

U.S. Pat. No. 10,053,165 for Automated Non-Destructive Inspection Of Surface Skins Using Transporter System by inventors Troy et al., filed Dec. 11, 2015 and issued Aug. 21, 2018, discloses systems and methods for automated maintenance of the top and bottom surfaces or skins of an integrally stiffened hollow structure (e.g., a horizontal stabilizer) using surface crawling vehicles. Each system uses dynamically controlled magnetic coupling to couple an external drive tractor to a pair of passive trailers disposed in the interior of the hollow structure on opposite sides of a vertical structural element. The external drive tractor is also coupled to an external maintenance tool, which the tractor pushes or pulls across the surface skin to perform a maintenance function. The systems allow maintenance operations to be performed on both surface skins without turning the hollow structure over. Each system is modular and can be transported to and easily set up in a building or factory.

U.S. Pat. No. 8,038,622 for Wired and wireless remotely controlled ultrasonic transducer and imaging apparatus by inventor Abraham, filed Jul. 30, 2008 and issued Oct. 18, 2011, discloses a remotely manipulatable transducer element or linear transducer array for use with a remote work station including a display permitting an operator of an ultrasound system to be remotely located from a patient. The transducer or linear transducer array comprises an assembly within a housing for fixation to a human body and intended to be placed one time and then remotely manipulated in directions of rotation, twist, and linearly in first and second perpendicular directions within a plane parallel to the surface of the human body under study. In one embodiment, the housing comprises a motor and a linear transducer array which are mounted to a rotor of the motor via an optional gear assembly for rotation, for example, in a range of 180 degrees so that multiple planes of imaging can be obtained, for example, of a heart or other body organ. The remotely manipulatable transducer or transducer array assembly may comprise a wireless transceiver having a unique identifier for communication with one or more work stations, each having a unique identifier.

U.S. Pat. No. 9,213,019 for Method Of Determining A Size Of A Defect Using An Ultrasonic Linear Phased Array by inventors Falsetti et al., filed Nov. 18, 2011 and issued Dec. 15, 2015, discloses a method and apparatus for determining a dimension of a defect in a component. A linear array of acoustic transducers is used to propagate a focused ultrasonic beam along a first focal line. The focused ultrasonic beam is moved across the defect in a first array direction substantially perpendicular to the first focal line. The dimension of the defect is determined from at least one reflection of the focused ultrasonic beam from the defect as the focused ultrasonic beam moves across the defect.

U.S. Pat. No. 8,414,495 for Ultrasound Patch Probe With Micro-Motor by inventors Halmann et al., filed Sep. 10, 2008 and issued Apr. 9, 2013, discloses an ultrasound probe for guidance procedures. The ultrasound probe includes a linear transducer array and a micro-motor configured to mechanically move the linear transducer array to provide ultrasound guidance of procedures.

US Patent Publication No. 2014/0336512 for High frequency, high frame-rate ultrasound imaging system by inventors Mehi et al., filed Jul. 24, 2014 and published Nov. 13, 2014, discloses a system for producing an ultrasound image comprising a scan head having a transducer capable of generating ultrasound energy at a frequency of at least 20 megahertz (MHz), and a processor for receiving ultrasound energy and for generating an ultrasound image at a frame rate of at least 15 frames per second (fps).

U.S. Pat. No. 9,429,546 for Phased array ultrasonic bolt inspection apparatus and method by inventors Williams et al., filed Mar. 24, 2014 and issued Aug. 30, 2016, discloses an ultrasonic bolt inspection apparatus and methods facilitating in situ as well as bench non-destructive evaluation (NDE) inspection of fastening bolt distal ends and their mating nuts. The apparatus is coupled to an exposed end of a fastener bolt head, its exposed thread tip or to a mating nut. The apparatus retains a phased array ultrasonic probe that generates inspection scan data and a rotational position encoder that generates rotational position data. The probe is coupled to an ultrasonic inspection system analyzer, which converts scan data into inspection data that characterizes possible defects in the inspected bolt. A system controller is coupled to the analyzer and the rotational position encoder, correlating rotation position data and inspection data, in order to identify location and characteristics of possible defects in the inspected bolt end.

US Patent Publication No. 2014/0088429 for Ultrasound imaging system and method by inventors Lomes et al., filed May 24, 2012 and published Mar. 27, 2014, discloses a method and system of producing an ultrasound image of an imaging region of a body, the image comprising pixels, the method including transmitting time-varying ultrasound into the imaging region, over a time interval, from a surface of the body, the transmitted ultrasound simultaneously having an angular spread in the imaging region corresponding to a plurality of the pixels of the image, receiving echoes of the transmitted ultrasound, and recording received signals of the echoes, and combining the received signals at the different sub-intervals of the time interval based on said time varying, according to expected ultrasound propagation times to scatterers localized at different pixels, to find image densities at the pixels.

U.S. Pat. No. 10,517,569 for Linear Magnetic Drive Transducer For Ultrasound Imaging by inventors Weitzel et al., filed Sep. 10, 2008 and issued Apr. 9, 2013, discloses an ultrasound imaging system using a magnetic linear motor driven ultrasound scanner, with accurate track and hold operation and/or other motion feedback, to scan a two dimensional or three dimensional area of a sample. The scanner is implemented in a low-power and low-bandwidth handheld device and is connected with a remote image processing system that receives raw data and performs full ultrasound image analysis and creation, allowing the handheld to be used for scanning, pre-processing, and display.

U.S. Pat. No. 10,765,403 for Ultrasonic measuring device, examination apparatus and method for operating same by inventors Tretbar et al., filed Feb. 18, 2013 and issued Sep. 8, 2020, discloses an ultrasonic measuring device including an ultrasonic array configured to detect ultrasonic signals, and a housing. The housing includes an acoustic window portion and a housing wall. The ultrasonic array is arranged in the housing in acoustic contact with the acoustic window portion. The acoustic window portion is configured to adhere to a surface of the object to be examined. The invention further relates to an examination apparatus, which includes at least one such ultrasonic measuring device, and to a method for ultrasonic signal detection, in particular for ultrasound-based imaging.

U.S. Pat. No. 8,091,423 for Weld verification system and method by inventors Zimmerman et al., filed Apr. 14, 2009 and issued Jan. 10, 2012, discloses an inspection method and system that locates a probe proximate a region of a shaft that is welded to a slug that secures the shaft to a housing. An acoustical wavefront may be emitted from the probe into the shaft toward the slug, and a reflection of the acoustical wavefront may be received with the probe. Whether the reflection occurred at an interface between the shaft and the slug or at a distal end of the slug is determined based on a time that the reflection is received by the probe.

U.S. Pat. No. 9,131,919 for Versatile breast ultrasound scanning by inventors Summers et al., filed Sep. 20, 2012 and issued Sep. 15, 2015, discloses versatile ultrasound scanning of a breast using an apparatus including a hand-manipulable compression/scanning assembly. The compression/scanning assembly comprises an ultrasound transducer and a compressive member comprising an at least partially conformable membrane in a substantially taut state, the membrane having a first surface compressing the breast in a generally chestward direction and a second surface opposite the first surface. The compression/scanning assembly further comprises a transducer translation mechanism coupled to the ultrasound transducer and configured to sweep the ultrasound transducer across the second surface of the membrane to scan the breast while compressed in the generally chestward direction. Systemized and/or standardized ultrasonic scanning of a breast based on hand-manipulable scanners having substantially planar scanning surfaces is also described.

U.S. Pat. No. 8,496,586 for Breast ultrasound examination including scanning through chestwardly compressing membrane and processing and displaying acquired ultrasound image information by inventors Zhang et al., filed Apr. 14, 2010 and issued Jul. 30, 2013, discloses navigation among breast ultrasound volumes derived from different volumetric ultrasonic scans of a same breast. On a display of a breast ultrasound workstation, a first image derived from a first ultrasonic volume is displayed. A user election of a source region of interest (ROI) in the first image is received. A destination ROI within a second ultrasonic volume is identified that at least roughly corresponds to a same locality of tissue in the breast as the source ROI. A second image derived from the second ultrasonic volume and including the destination ROI is displayed, the destination ROI being highlighted.

US Patent Publication No. 2008/0194959 for Breast Ultrasound Scanning Promoting Patient Comfort and Improved Imaging Near Chest Wall by inventors Wang et al., filed May 23, 2005 and published Aug. 14, 2008, discloses an apparatus and related methods for scanning a breast, the apparatus comprising a frame defining an orifice shaped to allow the breast to be received therein, a compressive member secured to the frame across the orifice that compresses the received breast toward the patient's chest wall, and a transducer positioned in acoustic communication with the compressive member for imaging the breast therethrough. The frame holds a reservoir of acoustically conductive fluid that maintains the transducer in acoustic communication with the compressive member. In different preferred embodiments having different advantages, the compressive member comprises a flexible elastic membrane, a flexible inelastic membrane, or a rigid sonolucent plastic preformed into the shape of a chestwardly-compressed breast. Where the transducer comprises one or more linear array probes, various probe orientations and trajectories are described for generating a three-dimensional volumetric representation of the breast having reduced nipple shadow effects.

US Patent Publication No. 2006/0173304 for Volumetric ultrasound scanning of smaller-sized breast by inventor Wang, filed Nov. 25, 2003 and published Aug. 3, 2006, discloses an apparatus and related methods for obtaining volumetric ultrasound scans of a breast of a supine patient in which a fluid reservoir including a bottom flexible membrane contacts an upward-facing surface of the breast. The fluid reservoir is filled with water or other suitable acoustically conductive fluid until the bottom membrane covering the breast is submerged. A transducer surface of an ultrasound probe is submerged in the fluid and moved over and/or around the breast area to obtain the ultrasound scans. Patient comfort is promoted, the patient being able to relax in a supine position during the procedure with a substantially uncompressed breast. Imaging near the chest wall is enhanced, especially for patients having smaller-sized breasts. Also described are preferred embodiments using multiple transducer surfaces in which shadowing effects are reduced.

U.S. Pat. No. 5,333,612 for Volumetric breast interrogation device by inventors Wild, filed Aug. 26, 1993 and issued Aug. 2, 1994, discloses a device for the rapid and complete interrogation of any portion of the body with specific attention to the breast and particularly the nipple-aerola area of the same for detection of abnormal, possibly cancerous, tissues within this normally difficult to examine area. The device includes an ultrasound transducer mounted in ultrasound conducting relationship to the area to be examined, positioned properly thereto and moved thereacross in a manner to provide a complete and systematic sweep of the area for total and rapid interrogation of the tissues within such area. The systematic sweep includes arcuate circumferential indexing of the transducer path moving radially across the breast. In this manner, the nipple-aerola area is repeatedly interrogated by each transducer travel across the breast. The transducer is also oscillated, normal to the path, as it travels along its path for cross sweep of tissue to insure total interrogation. The device may be hand held or may be suspended above the breast but maintaining transmissive contact therewith. Information gained through the interrogation is immediately revealed and detected in, “real time”, instant visualization and the device includes means for physically marking the location of the abnormal tissue on the breast, with visually discernable indicia, making maximally efficient mass screening of the populus possible.

US Patent Publication No. 2016/0243382 for Apparatus for generating high intensity focused ultrasound by inventor Jo, filed Mar. 4, 2015 and published Aug. 25, 2016, discloses an apparatus for generating high intensity focused ultrasound including: a housing which is filled with ultrasound transmitting medium; an ultrasound transducer which is movably disposed inside the housing; and a driving unit which linearly moves the ultrasound transducer.

U.S. Pat. No. 10,363,440 for Line-focused ultrasound transducer and high-intensity line focused ultrasound generator including same by inventors Cho et al., filed Dec. 6, 2013 and issued Jul. 30, 2019, discloses a line-focused ultrasound transducer and a high intensity line-focused ultrasound generation device including the same in which ultrasound is focused in a line so that the treatment time can be reduced and the structure can be simplified. A line-focused ultrasound transducer which focuses in a line shape includes: a therapeutic piezoelectric member having a hollow semi-cylindrical shape; a first electrode portion which is provided on an inner surface of the therapeutic piezoelectric member; and a second electrode portion which is provided on an outer surface of the therapeutic piezoelectric member in correspondence with the first electrode portion.

US Patent Publication No. 2010/0324423 for Apparatus for generating high intensity focused ultrasound by inventors El-Aklouk et al., filed Jun. 1, 2010 and published Dec. 23, 2010, discloses a method and device for ultrasound imaging including an array of transducers wherein the distance between adjacent transducers is greater than the minimum separation of adjacent scanlines required to produce an ultrasound image of a selected resolution. The transducer array is adapted to be mechanically moved so that the array may be swept to generate scanlines.

US Patent Publication No. 2013/0058195 for Device system and method for generating additive radiation forces with sound waves by inventors Cloutier et al., filed Jun. 29, 2012 and published Mar. 7, 2013, discloses a device, a system and a method for generating radiation forces in a region of interest. For doing so, a plurality of additive shear waves are generated in the region of interest.

U.S. Pat. No. 8,161,818 for Device for detecting a flaw in a component by inventors Elze et al., filed Oct. 27, 2009 and issued Apr. 24, 2012, discloses a device for detecting a flaw in a fibre-reinforced component, in particular delamination in a bearing region of a hole, by means of at least one probe, wherein an ultrasound field is emittable and detectable by means of the at least one probe. The ultrasound field is coupled according to the invention to the component at an angle of incidence a of greater than 0° from a normal of an upper side of a component. The oblique radiation enables a higher degree of resolution to be achieved when detecting delamination in the bearing region of holes. Further variants of the device operate using at least one linear probe received in a self-positioning holder. The rotating linear probe is composed of a plurality of individual vibrator elements which are arranged at regular intervals behind one another.

U.S. Pat. No. 8,964,507 for Systems and methods implementing frequency-steered acoustic arrays for 2D and 3D imaging by inventors Bachelor et al., filed Sep. 1, 2009 and issued Feb. 24, 2015, discloses acoustic arrays transmitting and/or receiving multiple, angularly dispersed acoustic beams to generate 2D and 3D images. The acoustic arrays may comprise frequency-steered acoustic arrays provided in one-dimensional linear and two dimensional planar and curvilinear configurations, which may be operated as single order or multiple order arrays, may employ periodic or non-periodic transducer element spacing, and may be mechanically scanned to generate 2D and 3D volumetric data. Methods and systems for operating acoustic arrays in a frequency-steered mode in combination a mechanical beam steering mode, electronic time-delay and phase shift beam forming modes, and phase comparison angle estimation modes are also provided. Methods for generating two and three dimensional images of underwater target scenes using multi-beam acoustic imaging systems are disclosed.

U.S. Pat. No. 8,974,392 for Ultrasonic probe by inventors Fujii et al., filed Jul. 19, 2007 and issued Mar. 10, 2015, discloses an ultrasonic probe having an organism contact portion that is shaped for use along a comparatively large curvature and can easily be used while closely contacting an organism. The probe includes a first cylinder pulley secured to a probe casing, an arm secured to a motor spindle extending through the first pulley, and a second cylinder pulley rotatably arranged on the opposite side and coupled to the first pulley by a wire. The second pulley is equipped with a slider shaft that is arranged to be extendable by a slider bearing. The slider shaft is equipped with a roller contacting a guide rail of the casing. An ultrasonic element is attached to the distal end of the slider shaft to provide the telescopic structure for the slider shaft. In this manner, the size of a scanning mechanism, for oscillating the ultrasonic element along a large curvature, is reduced.

US Patent Publication No. 2011/0167914 for Integrated Multi-Sensor Non-Destructive Testing by inventor Sutherland, filed Jun. 29, 2009 and published Jul. 14, 2011, discloses methods and apparatus for acquiring and processing data from a plurality of different sensor types for non-destructive testing of metallic structures. An electromagnetic acoustic transducer (EMAT) signal, an eddy current (EC) signal, a magnetic flux leakage (MFL) signal, and a deflection signal are acquired from each of a plurality of localized regions of a metallic structure, and are processed to characterize one or more features of the metallic structure based on at least two of the EMAT, EC, MFL, and deflection signals acquired from a common localized region in which at least a portion of the feature is located. An integrated multi-sensor device for non-destructive may be used to provide the EC, EMAT, MFL, and deflection signals for each of the plurality of localized regions of the metallic structure. Such integrated multi-sensor devices may be configured to provide an in-line inspection tool, such as an intelligent pig that is used to inspect the integrity of pipelines.

U.S. Pat. No. 7,650,790 for Method of inspecting a component and an apparatus for inspecting a component by inventor Wright, filed Aug. 6, 2007 and issued Jan. 26, 2010, discloses an apparatus for ultrasonically inspecting a component comprising a first ultrasonic transducer for transmitting an ultrasonic signal into a component having rotational symmetry and a second ultrasonic transducer for detecting the reflected, or transmitted, ultrasonic signal. A motor and a turntable produce relative rotation between the rotationally symmetrical component and the first and second transducers. Motors, a carriage and tracks on a frame provide relative radial motion between the rotationally symmetrical component and the first and second transducers to scan the whole of a surface of the rotationally symmetrical component. An ultrasonic signal analyzer analyses the detected ultrasonic signal by monitoring for ultrasonic signals having an amplitude above a predetermined amplitude and not having rotational symmetry and a display provides an indication that any detected ultrasonic signals above the predetermined amplitude and not having rotational symmetry is a potential flaw in the component.

U.S. Pat. No. 7,588,540 for Ultrasonic probe for scanning a volume by inventors Nguyen-Dinh et al., filed Apr. 8, 2005 and issued Sep. 15, 2009, discloses an ultrasonic imaging probe which is capable of capturing “on-the-fly” scanning planes in successive positions of the probe so as to form a volumetric image representation at a real time frame rate. The probe includes a flexible sealing membrane for a coupling fluid. Laterally extending folding portions of the flexible membrane provide fluid isolation and cancellation of parasitic constraining forces normally generated during probe movement.

U.S. Pat. No. 8,839,674 for Ultrasonic testing apparatus by inventor Jones, filed Jan. 19, 2010 and issued Sep. 23, 2014, discloses an ultrasonic testing apparatus including a base member having an aperture formed therein and a search member arranged to be rotatably received in the aperture of the base member and having at least one array aperture arranged to receive an ultrasonic array holder.

U.S. Pat. No. 10,792,011 for Systems and methods for hand-free continuous ultrasonic monitoring by inventors Toume et al., filed Dec. 14, 2017 and issued Oct. 6, 2020, discloses an assembly for hands-free ultrasonic monitoring and imaging via a suprasternal notch of a target individual, including a cradle comprising a lower portion having a surface shaped according to a surface of an anatomical region including a suprasternal notch of sample individual(s), and a holding portion connected to the lower portion, the holding portion shaped to fit a housing component, the holding portion including at least one elongated slot elongated at a predefined angle relative to the surface of the lower portion, and a housing component comprising: an ultrasound transducer, a multi-directional mechanism for adjusting the position of the ultrasound transducer within the housing component along at least two degrees of freedom, and a securing mechanism set at a location within housing component for engaging the at least one elongated slot of the cradle when housing component is fitted within the holding portion of the cradle.

U.S. Pat. No. 4,455,872 for Rotating ultrasonic scanner by inventors Kossoff et al., filed Apr. 25, 1983 and issued Jun. 26, 1984, discloses a rotating scanner for use in ultrasonic echoscopy having a linearly scanned transducer arrangement, for transmitting beams of ultrasonic energy into an object (and receiving reflected ultrasonic echoes from the object). The transducer arrangement is rotated about an axis passing through the center or one end of the linear scan. The linear scanning may be mechanical scanning, or by electronic switching of an array of transducer elements.

U.S. Pat. No. 8,323,201 for System and method for three-dimensional ultrasound imaging by inventors Towfiq et al., filed Aug. 6, 2008 and issued Dec. 4, 2012, discloses an ultrasound system for producing a representation of an object including a concave transducer array configured to transmit ultrasonic pulses into the object and to receive ultrasonic pulses from the object, the ultrasonic pulses from the object containing structural information about the object, each transducer in the array generating an output signal representative of a portion of the structural information about the object; a multi-focal lens structure for focusing the transmitted ultrasonic pulses; a multiplexing structure in operable communication with the concave transducer array and including logic for coupling the output signals from at least one pair of transducers in the concave transducer array; and a beamformer in operable communication with the multiplexing structure and including logic for constructing a representation of structural information about the object based on the coupled output signals from the multiplexing structure.

U.S. Pat. No. 9,354,204 for Ultrasonic tomography systems for nondestructive testing by inventor Kleinert, filed Oct. 14, 2011 and issued May 31, 2016, discloses a system including a segmented transducer probe. The segmented transducer probe includes a plurality of transducer segments adapted to transmit ultrasonic excitation signals into a test specimen and to receive echo signals resulting from the interaction of the ultrasonic excitation signals and the test specimen. The system also includes a processing system adapted to receive data from the segmented transducer probe that corresponds to the received echo signals and to utilize tomographic reconstruction methods to reconstruct an image corresponding to at least one volumetric slice of the test specimen.

US Patent Publication No. 2006/0173350 for Systems and methods for three dimensional imaging with an orientation adjustable array by inventors Yuan et al., filed Jan. 11, 2005 and published Aug. 3, 2006, discloses systems and methods allowing for three dimensional imaging with a medical ultrasound imaging system having an orientation adjustable imaging device. The imaging device can include a transducer array configured to image an imaging field in two dimensions. The imaging device can also include an orientation adjustment unit configured to adjust the orientation of the array in a third dimension. The array can be configured to image the two dimensional imaging field at multiple different orientations. An image processing system can be communicatively coupled with the array and configured to assemble the image data collected across each imaging field at multiple orientations of the array. The assembled data can then be displayed as a three dimensional image.

U.S. Pat. No. 9,883,847 for Ultrasonic tomography systems for nondestructive testing by inventor Kleinert, filed Jan. 29, 2015 and issued Feb. 6, 2018, discloses techniques for ultrasound location of obstructions during OSA including an ultrasound transducer array configured, upon receipt of a signal, to obtain first data that supports a plurality of ultrasound images representing a corresponding plurality of cross sections of an airway in a neck of a subject. Second data is received automatically on a processor, from an apnea event sensor set that is configured to collect automatically the second data sensitive to an apnea event in the subject. An apnea event is detected automatically on the processor based on the second data. In response to detecting the apnea event, the signal is automatically sent to the ultrasound transducer array, wherein the signal is the signal that causes the ultrasound transducer array to obtain the first data. Image data based on the first data is automatically stored in a computer-readable medium.

U.S. Pat. No. 5,974,889 for Ultrasonic multi-transducer rotatable scanning apparatus and method of use thereof by inventor Trantow, filed Jan. 2, 1998 and issued Nov. 2, 1999, discloses an apparatus for ultrasonically scanning a surface including a plurality of pairs of 180 degree oppositely disposed transducers mounted in a rotatable head having a central axis about which the head is rotatable. A positioning system for positioning the transducers such that all beam axes of the transducers intersect the central axis at a single point. Axes of each pair are equiangular with respect to the centerline and axes of different pairs have incident and reflective angles between beam axes and the central axis that are different from those of other pairs. Incident and reflective angles of different pairs of transducers are preferably predetermined and in close proximity to a predetermined angle over a range of angles bracketing a predetermined critical angle. A translating system is preferably included for effecting translational motion between the head and the surface such that the single point lies substantially on the surface during scanning. The present method further provides a non-destructive material evaluation technique to determine effective Rayleigh wave critical angles using the apparatus. The effective critical angle may be determined from an angular beam intensity profile generated from the beam intensity data provided by each pair of fixed angle transducers.

U.S. Pat. No. 8,206,307 for Ultrasound imaging probe and method by inventors Barnard et al., filed Nov. 17, 2010 and issued Jun. 26, 2012, discloses an ultrasound probe having an ultrasound module received in a housing thereof, the ultrasound module including a plurality of transducers longitudinally spaced apart within the housing and a control and processing system electrically coupled to the transducers for collecting ultrasonic data representative of a target biological tissue when the ultrasound probe is in operation. A motor is likewise received in the housing to rotate, oscillate and/or translate the ultrasound module in a data collection mode. Coupling fluid is received in the housing to at least partially surround the ultrasound module and the motor. A method of obtaining ultrasonic data representative of a target biological tissue, such as a bladder, for diagnostic purposes is also provided.

U.S. Pat. No. 8,316,714 for Scan patterns for electronically positioned apertures on an array by inventor Guracar, filed May 14, 2010 and issued Nov. 27, 2012, discloses a plane or volume being scanned with ultrasound. Electronic movement of apertures is used during the scanning. Scanning with the apertures is interleaved. The apertures move along the array in opposite directions, preventing or limiting large temporal discontinuity. For example, two apertures begin at similar angles on a two-dimensional array. Planar scans are performed for each aperture location. The apertures are counter rotated (i.e., one clockwise and the other counter clockwise).

U.S. Pat. No. 9,945,817 for Specially Designed Phased Array Transducer For The Inspection Of Fastener Holes And Adjacent Structure Without The Removal Of The Fastener by inventors Pember et al., filed Aug. 4, 2015 and issued Apr. 17, 2018, discloses a phased array transducer for inspecting a fastener hole and adjacent structure to identify defects and determine hole integrity without removing the fastener from the hole. The phased array transducer includes a plurality of transducer elements, where one of the transducer elements is used to align the transducer to the hole, one group of the remaining transducer elements inspects the entire thickness of the structure at one side of the fastener and another group of the remaining transducer elements inspects the entire thickness of the structure at an opposite side of the fastener.

U.S. Pat. No. 10,502,716 for Systems and methods for viewing data generated by rotational scanning in non-destructive testing by inventors Oberdoerfer et al., filed Jan. 15, 2018 and issued Dec. 10, 2019, discloses a testing system for testing a work piece. The testing system may be non-destructive. An associated method. The method may include obtaining C-scan images and corresponding S-scan images. The C-scan images and the corresponding S-scan images are of the same portion of the work piece being tested.

U.S. Pat. No. 10,241,199 for Ultrasonic/photoacoustic imaging devices and methods by inventors Witte et al., filed Nov. 4, 2014 and issued Mar. 26, 2019, discloses obtaining data of a sample, particularly data capable of being processed to produce an image of a region of the sample. An exemplary device includes a light-beam source, an acoustic-wave source, an optical element, and an acoustic detector. The optical element is transmissive to a light beam produced by the light-beam source and reflective to acoustic waves produced by the acoustic-wave source. The optical element is situated to direct the transmitted light beam and reflected acoustic wave simultaneously along an optical axis to be incident at a situs in or on a sample to cause the sample to produce acoustic echoes from the incident acoustic waves while also producing photoacoustic waves from the incident light beam photoacoustically interacting with the situs. The acoustic detector is placed to receive and detect the acoustic echoes and the photoacoustic waves from the situs. The acoustic detector can comprise one or more hydrophones exploiting the acousto-electric effect.

US Patent Publication No. 2020/0405268 for Suppression Of Multiple Scattering Noise In Pulse Echo Imaging by inventors Angelsen et al., filed Jun. 24, 2020 and published Dec. 31, 2020, discloses methods and instrumentation for pulse scattering estimation and imaging of scattering parameters in a material object by transmitting a pulse along a transmit beam and directing a receive beam that crosses at least one transmit beam at an angle <45 deg. The receive beam is at least in an azimuth direction at the transmit beam, and records scattered receive signal from the overlap region. A receive interval of the receive signal is gated for further processing to form measurement and/or image signals from cross-beam observation cells.

US Patent Publication No. 2019/0366127 for Devices and methods for multi-focus ultrasound therapy by inventor Emery, filed Aug. 15, 2019 and published Dec. 5, 2019, discloses a dermatological cosmetic treatment and imaging system and method including use of transducer to simultaneously or substantially simultaneously produce multiple cosmetic treatment zones in tissue. The system can include a hand wand, a removable transducer module, a control module, and/or graphical user interface. In some embodiments, the cosmetic treatment system may be used in cosmetic procedures, including brow lifts, fat reduction, sweat reduction, and treatment of the décolletage. Skin tightening, lifting and amelioration of wrinkles and stretch marks are provided.

US Patent Publication No. 2013/0172751 for Systems and methods for shock absorbing in ultrasound probes by inventors Heinrich et al., filed Jan. 2, 2012 and published Jul. 4, 2013, discloses methods and systems for shock absorbing in ultrasound probes. One ultrasound probe has a housing and a scan head within the housing, wherein the scan head includes a transducer array. The ultrasound provide further includes an axle coupled to the scan head allowing rotation of the scan head and a shock absorbing member within the scan head coupled between the transducer array and the axle. The shock absorbing member is configured to allow relative movement between the axle and the transducer array.

US Patent Publication No. 2007/0167821 for Rotatable transducer array for volumetric ultrasound by inventors Lee et al., filed Nov. 30, 2005 and published Jul. 19, 2007, discloses a rotating transducer assembly and method for use in volumetric ultrasound imaging and catheter-guided procedures. The rotating transducer assembly comprises a transducer array mounted on a drive shaft and the transducer array is rotatable with the drive shaft, a motion controller coupled to the transducer array and the drive shaft for rotating the transducer, and at least one interconnect assembly coupled to the transducer for transmitting signals between the transducer and an imaging device, wherein the interconnection assembly is configured to reduce its respective torque load on the transducer and motion controller due to a rotating motion of the transducer.

### SUMMARY OF THE INVENTION

The present invention relates to phased array ultrasonic testing devices, and more specifically to housings for linear phased arrays for simulating a two-dimensional (2D) matrix of transducer elements.

It is an object of this invention to provide a portable device including a true linear phased array able to translate in order to simulate a scan performed by a two-dimensional matrix of transducer elements.

In one embodiment, the present invention is directed to a phased array scanning device, including a frame including a top base and side walls extending downwardly from edges of the top base, at least one deformable bladder stretched between bottom ends of the side walls, such that the at least one deformable bladder, the top base, and the side walls define an interior chamber, at least one linear array of ultrasonic transducers within the interior chamber, and at least one motor operable to translate the at least one linear array across the length and/or width of the interior chamber, wherein the interior chamber or a section of the interior chamber includes at least one coupling substance.

In another embodiment, the present invention is directed to a method for performing non-destructive testing, including providing a frame including a top base and side walls extending downwardly from edges of the top base and having at least one deformable bladder stretched between bottom ends of the side walls, such that the at least one deformable bladder, the top base, and the side walls define an interior chamber, at least one motor translating at least one linear array of ultrasonic transducers within the interior chamber across the length and/or width of the interior chamber, and one or more pulser receivers individually firing each transducer in the at least one linear array of ultrasonic transducers according to a predetermined pattern.

In yet another embodiment, the present invention is directed to a phased array scanning device, including a frame including a top base and side walls extending downwardly from edges of the top base, at least one deformable bladder stretched between bottom ends of the side walls, such that the at least one deformable bladder, the top base, and the side walls define an interior chamber, at least one linear array of scanning elements within the interior chamber, and at least one motor operable to translate the at least one linear array across the length and/or width of the interior chamber, wherein the at least one linear array is operable to pivot at one end of the linear array, such that the at least one linear array is able to rotate by approximately 90 degrees.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates a perspective view of a phased array housing device according to one embodiment of the present invention.

FIG. 2 illustrates a side view of a phased array housing device according to one embodiment of the present invention.

FIG. 3 illustrates a bottom view of a phased array housing device according to one embodiment of the present invention.

FIG. 4 illustrates a bottom view of a phased array housing device after a full scan in a first direction according to one embodiment.

FIG. 5 illustrates a bottom view of a phased array housing device with a linear phased array rotated for a second in a second direction according to one embodiment of the present invention.

FIG. 6 illustrates a bottom view of a phased array housing device with multiple linear phased arrays moving along the same axis according to one embodiment of the present invention.

FIG. 7 illustrates a bottom view of a phased array housing device with multiple linear phased arrays moving along different axes according to one embodiment of the present invention.

FIG. 8 illustrates a bottom view of a phased array housing device having a circular cross-section according to one embodiment of the present invention.

FIG. 9 illustrates a bottom view of a phased array housing device having a circular cross-section according to one embodiment of the present invention.

FIG. 10 illustrates a perspective view of a phased array housing device including a display screen according to one embodiment of the present invention.

FIG. 11 illustrates a bottom view of a phased array housing device including irrigation channels according to one embodiment of the present invention.

FIG. 12 illustrates a side view of a phased array housing device including irrigation channels according to one embodiment of the present invention.

FIG. 13 illustrates an ultrasonic element according to one embodiment of the present invention.

FIG. 14 is a schematic diagram of a system of the present invention.

### DETAILED DESCRIPTION

The present invention is generally directed to phased array ultrasonic testing devices, and more specifically to housings for linear phased arrays for simulating a two-dimensional (2D) matrix of transducer elements having a high density of transducer array elements.

In one embodiment, the present invention is directed to a phased array scanning device, including a frame including a top base and side walls extending downwardly from edges of the top base, at least one deformable bladder stretched between bottom ends of the side walls, such that the at least one deformable bladder, the top base, and the side walls define an interior chamber, at least one linear array of ultrasonic transducers within the interior chamber, and at least one motor operable to translate the at least one linear array across the length and/or width of the interior chamber, wherein the interior chamber or a section of the interior chamber includes at least one coupling substance.

In another embodiment, the present invention is directed to a method for performing non-destructive testing, including providing a frame including a top base and side walls extending downwardly from edges of the top base and having at least one deformable bladder stretched between bottom ends of the side walls, such that the at least one deformable bladder, the top base, and the side walls define an interior chamber, at least one motor translating at least one linear array of ultrasonic transducers within the interior chamber across the length and/or width of the interior chamber, and one or more pulser receivers individually firing each transducer in the at least one linear array of ultrasonic transducers according to a predetermined pattern.

In yet another embodiment, the present invention is directed to a phased array scanning device, including a frame including a top base and side walls extending downwardly from edges of the top base, at least one deformable bladder stretched between bottom ends of the side walls, such that the at least one deformable bladder, the top base, and the side walls define an interior chamber, at least one linear array of scanning elements within the interior chamber, and at least one motor operable to translate the at least one linear array across the length and/or width of the interior chamber, wherein the at least one linear array is operable to pivot at one end of the linear array, such that the at least one linear array is able to rotate by approximately 90 degrees.

In most circumstances, it is prohibitively expensive and technically very difficult to create a true phased array of 128×128 individually fireable transducer elements, especially small enough to scan a small region (e.g., a four square inch region). However, some prior art inventions have attempted to address this issue. For example, U.S. Pat. No. 10,866,314, which is incorporated herein by reference in its entirety, discloses a pseudo-phased array device marketed by DOLPHITECH. The '314 patent discloses a matrix array of transducer elements, wherein “the matrix array may comprise a number of parallel, elongated electrodes arranged in an intersecting pattern; the intersections form[ing] the transducer elements.” However, the DOLPHITECH device is limited, in that it is incapable of individually firing each element, limiting the resolution and control of the device. Therefore, the DOLPHITECH is unable to precisely use focal laws and therefore, unable to accurately utilize beam steering techniques common in phased array scanning. Therefore, what is needed is a device capable of accurately simulating a full two-dimensional (2D) phased array device, while also allowing truly isolated elements to be individually fired.

Referring now to the drawings in general, the illustrations are for the purpose of describing one or more preferred embodiments of the invention and are not intended to limit the invention thereto.

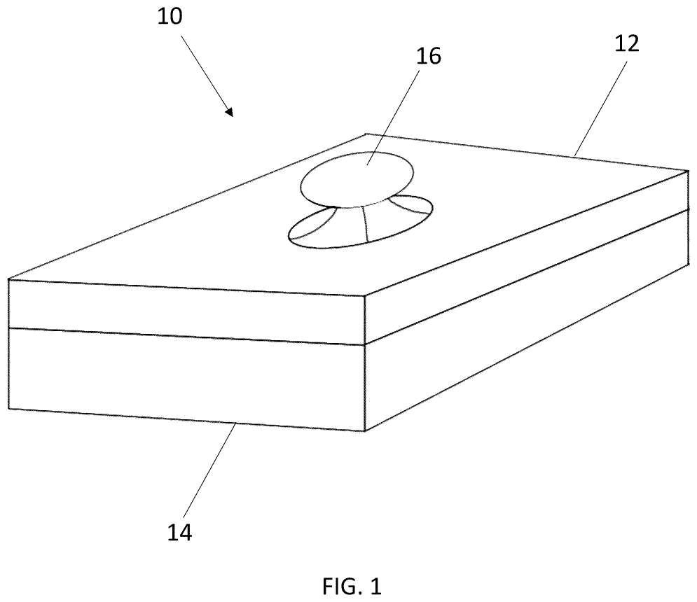

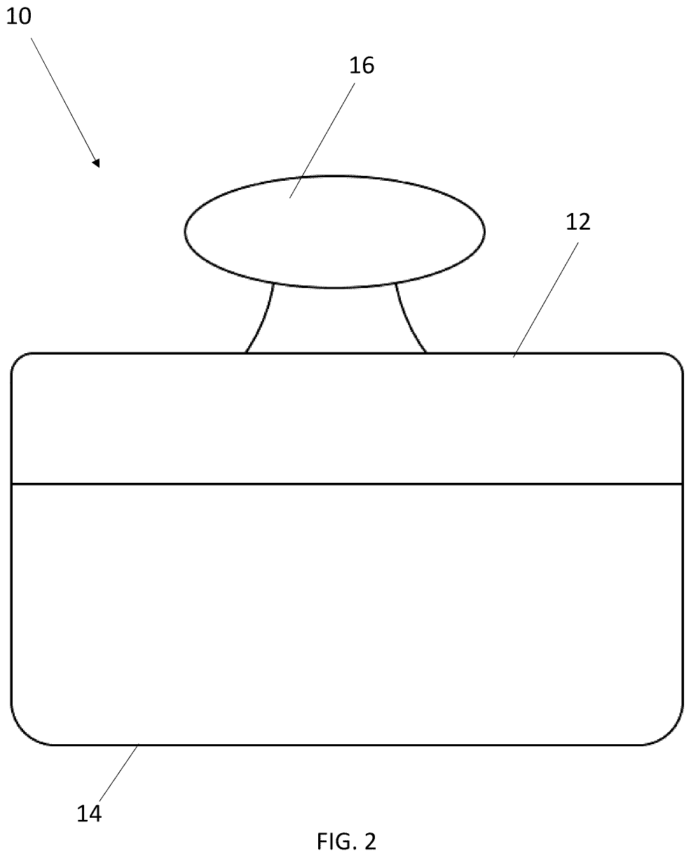

FIGS. 1 and 2 illustrate a phased array housing device according to one embodiment of the present invention. A phased array housing device 10 includes a transducer housing section 12 attached to a couplant housing section 14. In one embodiment, a handle 16 extends outwardly from a top surface of the transducer housing section 12. The phased array housing device 10 contains a linear phased array of ultrasonic transducers. The couplant housing section 14 is a sealed compartment, containing one or more coupling substances, operable to acoustically couple the linear phased array to a test object. In one embodiment, the coupling substance is a liquid or colloidal couplant, such as water or acoustic gel. In another embodiment, the coupling substance is a solid couplant, such as a polymer block, including an acoustically coupling polymer such as AQUALENE. In yet another embodiment, the coupling substance is a gas, such as air. One of ordinary skill in the art will understand that the coupling substances contained in the couplant housing section 14 are not intended to be limiting, and are able to include multiple types of coupling substances within the same couplant housing section 14.

One of ordinary skill in the art will understand that the phased array housing device 10 is not limited to including only ultrasonic phased array devices. For example, in an alternative embodiment, the linear phased array includes a plurality of eddy current coils. In other embodiments, the linear phased array includes a plurality of radiofrequency (RF) probes (e.g., microwave, terahertz, millimeter wave) or a plurality of electromagnetic-based probes (e.g., eddy current, magneto-resistance (MR), etc.). Furthermore, one of ordinary skill in the art will understand that, where the phased array housing device 10 includes a plurality of ultrasonic transducers, the system is not limited to any particular method of ultrasonic. For example, in one embodiment, the phased array housing device 10 is able to utilize laser ultrasound in order to scan a test object.

In one embodiment, the transducer housing section 12 and/or the couplant housing section 14 are formed from transparent polymer materials (e.g., polycarbonate, polymethyl methacrylate (PMMA), polyethylene terephthalate (PET), polyvinyl chloride (PVC), polyethylene (PE), polypropylene (PP), liquid silicone rubber, etc.). In another embodiment, the couplant housing section 14 includes glass. In one embodiment, the coupling housing section 14 is formed from a coupling polymer material, such as AQUALENE. In one embodiment, the couplant housing section 14 is a rigid solid part, wherein the sides of the couplant housing section are not easily deformable. In another embodiment, the couplant housing section 14 is formed from a soft, easily deformable material, such that the couplant housing section 14 acts as a bladder. The bladder is able to deform to the surface of adjacent parts, reducing the issue of air pockets forming between the couplant housing section 14 and the test object, thereby reducing acoustic mismatches causing additional attenuation of the ultrasonic waves. Using a deformable material is particular useful in examining parts with more complex geometries (e.g., fasteners). In one embodiment, the side walls of the couplant housing section 14 are formed from a rigid material, while the bottom surface of the couplant housing section 14 acts as an “acoustic window” and is formed from a soft, deformable coupling material. One of ordinary skill in the art will understand that the materials used for the transducer housing section 12 and the couplant housing section 14 are not intended to be limiting according to the present invention.

One of ordinary skill in the art will understand that techniques of phased array scanning able to be used with the present invention are not intended to be limiting. For example, the linear phased array within the phased array housing device 10 is able to use the total focusing method (TFM), sectorial scanning, and/or any other type of phased array scanning.

In one embodiment, the couplant housing section 14 includes at least one slit and/or hole configured to contact the test object. This allows the system to serve as a “weeping” system with couplant (e.g., water) constantly leaking onto the test object in order to provide an acoustic path between the transducer and the test object. In one embodiment, the phased array housing device 10 includes an active pump operable to constantly pump acoustic couplant (e.g., water) into the couplant housing section 14 in order to replace acoustic couplant that leaks out through the slit and/or hole.

In one embodiment, the couplant housing section 14 includes one or more attachment regions (e.g., clips, straps, etc.) configured to attachment to a lens of known radii. In one embodiment, the lens of known radii is formed from an acoustic coupling material (e.g., AQUALENE). By configuring the couplant housing section 14 to attach to different lenses of known radii, the phased array housing device 10 is able to conform to different parts that have different radii of curvature while fitting snugly against the part.

In one embodiment, the couplant housing section 14 of the phased array housing device 10 includes at least one suction cup configured to attach the phased array housing device 10 to the test object. The at least one suction cup serves to stabilize the phased array housing device 10 on the surface of the test object. In one embodiment, the couplant housing section 14 of the phased array housing device 10 includes at least one magnet. Similar to the at least one suction cup, the at least one magnet is able to stabilize the phased array housing device 10 if the test object is magnetic.

In one embodiment, at least one irrigation line and/or at least one vacuum line is attached to the phased array housing device 10. The at least one irrigation line and/or the at least one vacuum line are operable to suction fluid acoustic couplant out of the couplant housing section 14 in order to remove excess couplant.

In one embodiment, the handle 16 is integrally formed with the transducer housing section 12. In another embodiment, the handle 16 is attached to the transducer housing section 12 via one or more attachment means (e.g., one or more nails, one or more screws, one or more bolts, magnetic attachment, adhesive attachment, one or more clips, etc.). In one embodiment, in addition to or in lieu of a handle 16, the phased array housing device 10 includes at least one robotic attachment region. In one embodiment, the robotic attachment region includes at least one magnet, at least one clip, at least one opening configured for receiving a screw, nail, bolt, etc., at least one protrusion operable to be received by a robotic unit, and/or any other means for attachment. In one embodiment, the robotic attachment region is configured to connect the phased array housing device 10 to at least one robotic arm, at least one robotic crawler, at least one translation stage, and/or at least one drone configured to move the phased array housing device 10 along a surface of the test object. In one embodiment, the robotic attachment region connects to a gimbal system of the at least one robotic crawler, at least one translation stage, at least one robotic arm, and/or at least one drone, allowing the phased array housing device 10 to rotate relative to the attached system, and therefore allowing the system to scan harder-to-reach areas. Furthermore, the gimbal system allows the phased array housing device to be more consistently positioned normal to the surface of the test object. In one embodiment, a drone is configured to transport the phased array housing device 10 to a location on a test object, and extend at least one translation arm such that the phased array housing device 10 is securely pressed against a surface of the test object before moving the phased array housing device 10 to another location on the test object.

In one embodiment, the at least one crawler, the at least one robotic arm, and/or the at least one drone includes at least one inspection alignment sensor. The inspection alignment sensor allows the at least one crawler, the at least one robotic arm, and/or the at least one drone to use computer vision to automatically move the phased array housing device 10 to an area of interest. In one embodiment, the at least one inspection alignment sensor includes at least one camera, at least one LiDAR sensor, at least one thermographic probe, at least one ultrasonic probe, at least one eddy current probe, and/or any other type of imaging system. In one embodiment, the at least one inspection alignment sensor detects at least one area of possible damage (e.g., an area with a found defect) and the phased array housing device 10 is automatically moved to scan the at least one area of possible damage. In another embodiment, the at least one inspection alignment sensor is used to identify specific features of the test object, such as rivets and bolt hole locations. The phased array housing device 10 of the present invention is particularly useful for scanning areas around rivets and bolt holes, and thus, the phased array housing device 10 is automatically moved by the at least one crawler, the at least one robotic arm, and/or the at least one drone to scan the areas with rivets and/or bolt holes.

In one embodiment, the firing rate of the elements in the linear array is approximately 1-20 kHz.

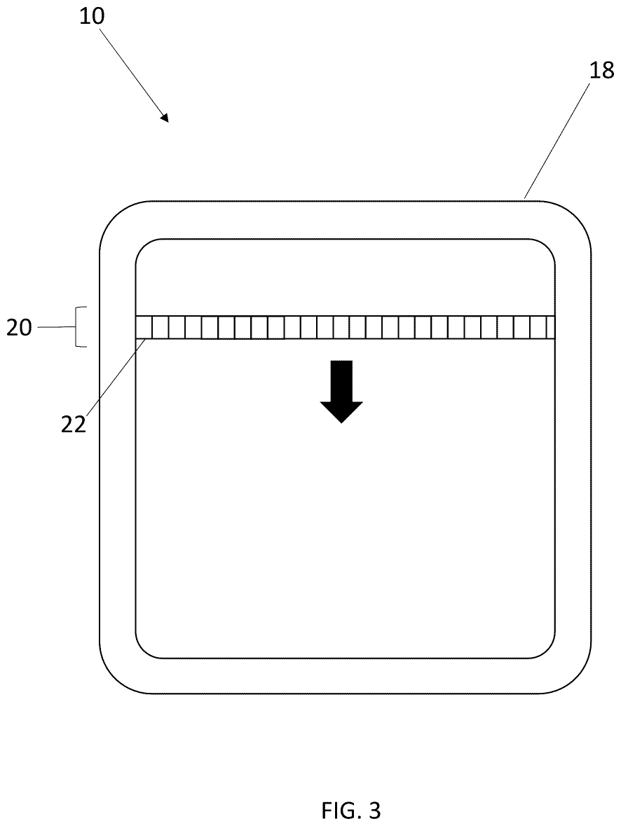

FIG. 3 illustrates a bottom view of a phased array housing device according to one embodiment of the present invention. In one embodiment the linear array 20, including a plurality of ultrasonic transducer elements 22, is attached to opposite side walls of the rim 18 of the phased array housing section. In one embodiment, the linear array 20 is attached to grooves along the opposite side walls of the rim 18 of the phased array housing section and operable to be moved along length of the phased array housing section by a motor. One of ordinary skill in the art will understand that methods for translating the linear phased array are not intended to be limited to a motor (i.e., the linear phased array is also capable of being moved by a belt system, or any other movement system). In one embodiment, the linear array 20 is coupled to an encoder, operable to produce location data for the linear array 20 relative to the rim 18 of the phased array housing section at various time points. In another embodiment, the location of the linear phased array 20 is able to be determined by determining a number of steps moved by a stepper motor translating the linear phased array. Each transducer element 22 of the linear array 20 is individually attached to one or more pulser-receivers, such that each transducer element 22 is capable of being individually fired.

In one embodiment, the linear array 20 includes 64 elements. In another embodiment, the linear array 20 includes 128 elements. In one embodiment, the length of the linear array 20 is less than or equal to approximately one inch, meaning the device has a very high element density. One of ordinary skill in the art will understand that the number of elements in the linear array 20 is not intended to be limiting according to the present invention. Advantageously, including only a single linear array 20 of elements 22, rather than a full matrix of elements reduces the complexity and cost of the device, while still providing for the improved resolution of a phased array matrix when the single linear array 20 is translated.

In one embodiment, the linear array 20 moves across the length of the phased array housing device in between approximately 1 second and approximately 30 seconds. In one embodiment, the linear array 20 moves across the length of the phased array housing device in between approximately 2 seconds and approximately 5 seconds.

In one embodiment, the couplant housing section does not cover the entirety of the bottom of the transducer housing section at any one time. By way of example and not limitation, in one embodiment, the couplant housing section is attached directly to the linear phased array 20 and has approximately the same thickness and/or length as the linear phased array 20. In this embodiment, the couplant housing section moves with the linear phased array, reducing the overall footprint of the device.

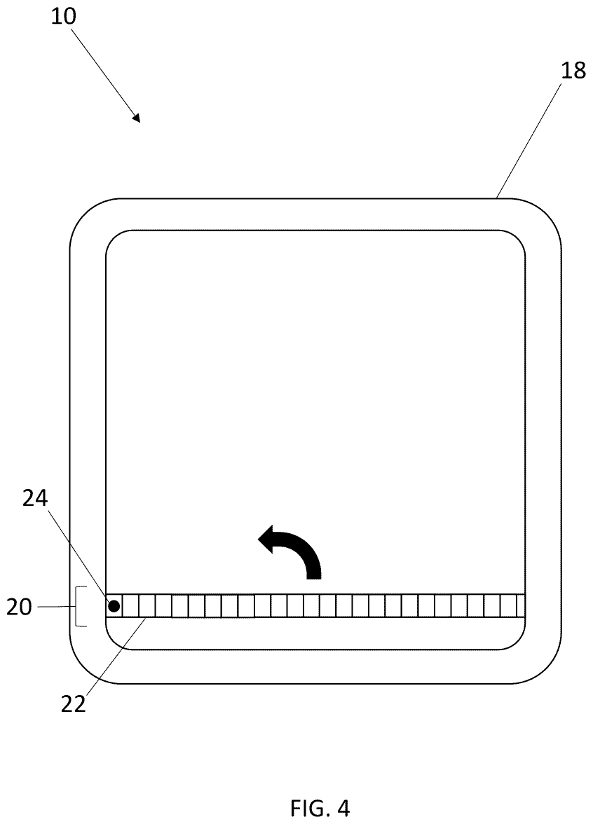

FIG. 4 illustrates a bottom view of a phased array housing device after a full scan in a first direction according to one embodiment. In one embodiment, after the linear phased array 20 reaches one end of the transducer housing section, it automatically attaches to a pivot point attached to one end of the linear array 20. In one embodiment, one end of the linear phased array 20 includes an opening. When the linear phased array 20 reaches the end of the transducer housing section, a pin is automatically inserted into the opening, allowing the linear phased array to pivot about the pin. In another embodiment, one end of the linear phased array 20 includes a clip. When the linear phased array 20 reaches the end of the transducer housing section, the clip automatically attaches to one end of the linear phased array 20, allowing the linear phased array 20 to pivot about the clip.

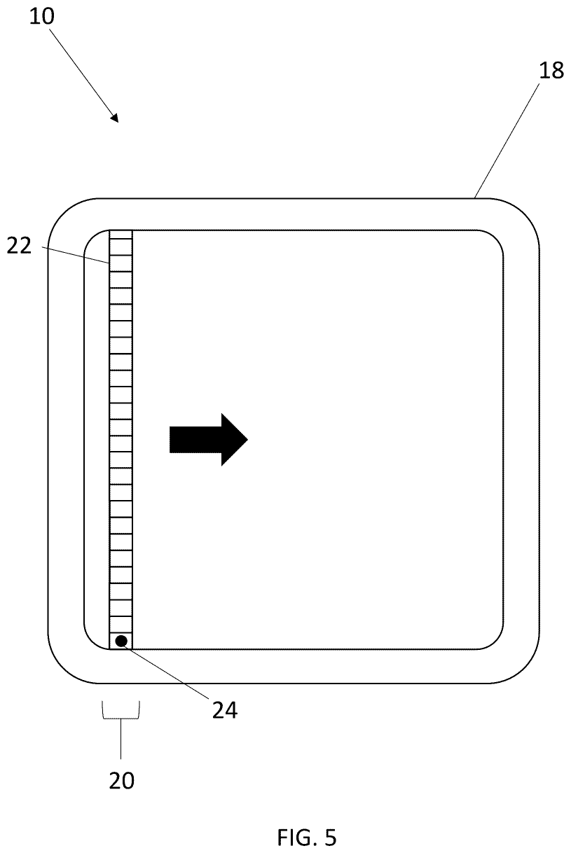

FIG. 5 illustrates a bottom view of a phased array housing device with a linear phased array rotated for a second in a second direction according to one embodiment of the present invention. In one embodiment, the linear array 20 rotates about the pivot point 24. After rotating about the pivot point 24, the linear array 20 is operable to translate within the transducer housing section in a direction orthogonal to the original direction of translation. In one embodiment, the linear array 20 attaches to linear grooves within opposite walls of the transducer housing section (wherein the opposite walls are distinct from those attached to when translating in the first direction) and is operable to be driven by a motor to translate along the linear grooves. Moving the linear phased array 20 in a second direction helps in identifying features that are less easily visible when scanning in a first direction.

In one embodiment, as shown in FIG. 5, the linear phased array 20 rotates by approximately 90 degrees such that the linear phased array is able to move in a direction approximately orthogonal to the original direction of translation. However, one of ordinary skill in the art will understand that the rotation is not limited to full 90 degree turns. In another embodiment, for example, the linear phased array is able to rotate approximately 45 degrees.

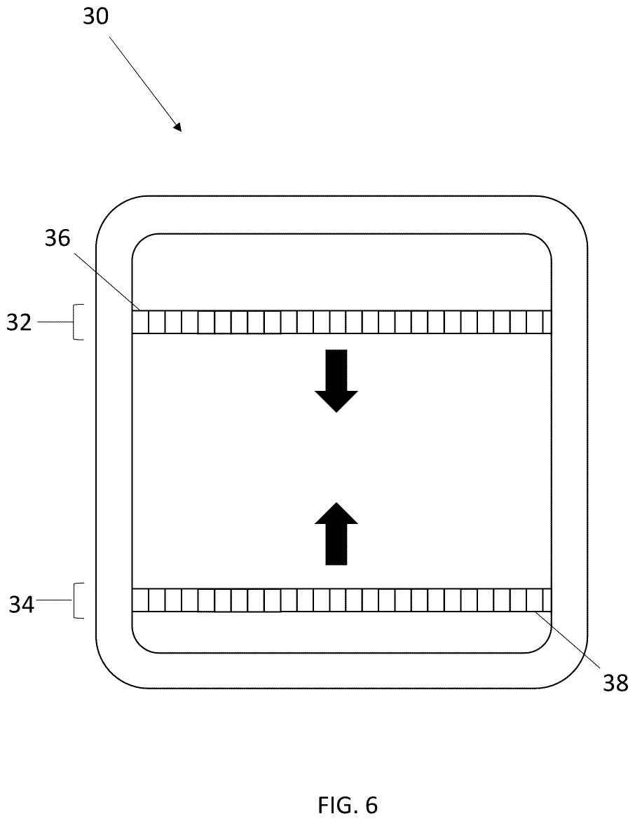

FIG. 6 illustrates a bottom view of a phased array housing device with multiple linear phased arrays according to one embodiment of the present invention. In one embodiment, the transducer housing section of a phased array housing device 30 includes a first linear array 32, including a first set of transducer elements 36, a second linear array 34, including a second set of transducer elements 38. In one embodiment, the first linear array 32 and the second linear array 34 both translate along the length of the transducer housing section. Increasing the number of linear arrays increases the speed of the scan performed, increases the area able to be scanned at once, and/or produces more data covering the same region, thereby simplifying data fusion.

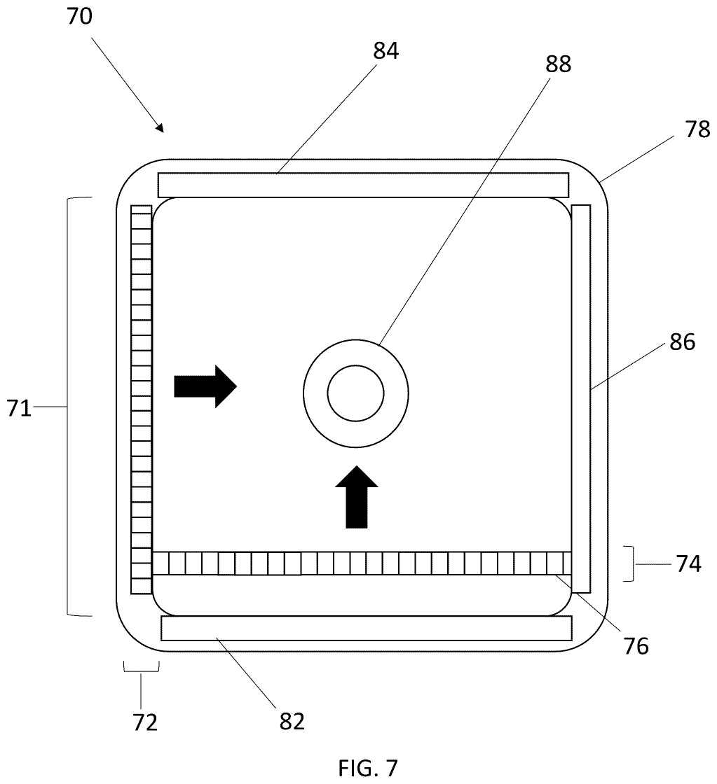

FIG. 7 illustrates a bottom view of a phased array housing device with multiple linear phased arrays moving along different axes according to one embodiment of the present invention. The phased array housing device 70 includes a first linear phased array 72 and a second linear phased array 74, each including a plurality of transducer elements 76, configured to move to orthogonal directions across the bottom of the phased array housing device 70. The scanning takes place in an active window 71 of the phased array housing device 70 surrounded by a rim 78 along the edges of the phased array housing device 70. However, in order to prevent first linear phased array 72 from blocking the movement of the second linear phased array 74 (or vice versa), the linear phased arrays cannot sit in the active window 71 while at rest. Therefore, in one embodiment, the rim 78 of the phased array housing device 70 include a plurality of pockets 82, 84, 86, configured to house the linear phased arrays 72, 74 while at rest. For example, as shown in FIG. 7, the second linear phased array 74 moves out of a first pocket 82 to initiate a scan and into a second pocket 84 when the scan is complete. The first linear array 72 is shown inside of a third pocket in FIG. 7. After the second linear phased array 74 fully traverses the active window 71, the first linear phased array 72 begins scanning, ultimately moving into a fourth pocket 86 when the scan is complete. One of ordinary skill in the art will understand that four pockets are not necessary in order for the phased array housing device 70 to function. For example, in one embodiment, each linear phased array only has a single corresponding pocket, and each linear phased array moves out of and back into the same pocket upon beginning and ending a scan respectively.

Typically, a single outgoing connector from a phased array housing device is only able to connect to a maximum of 128 ultrasonic elements at one time. Therefore, if both the first linear phased array 72 and the second linear phased array 74 include 128 elements, a system would require multiple connectors in order to function. However, including multiple connectors is likely to undesirably limit the portability of the device. In one embodiment, in order to resolve this issue, the phased array housing device 70 includes only a single outgoing connector initially connected to the elements in the first linear phased array 72. When the first linear phased array 72 has completed a full translation across the active window 71, the single outgoing connector automatically switches to connect with the elements of the second linear phased array 74.

In one embodiment, at least one imager 88 is positioned behind the first linear phased array 72 and the second linear phased array 74. When both the first linear phased array 72 and the second linear phased array 74 are in corresponding pockets, active window 71 is open and the at least one imager 88 is able to take an image of the surface of the test object for reference. In one embodiment, the at least one imager 88 includes at least one camera, at least one thermographic scanning device, at least one laser scanning device, and/or any other type of imaging device. One of ordinary skill in the art will understand that the at least one imager 88 is able to take an image before movement of either linear phased array, after scanning by the first linear phased array 72 but before scanning by the second linear phased array 74, or after scanning by both linear phased arrays. Importantly, this imaging is only possible because the system does not use a true 2D phased array, which would otherwise block the image.

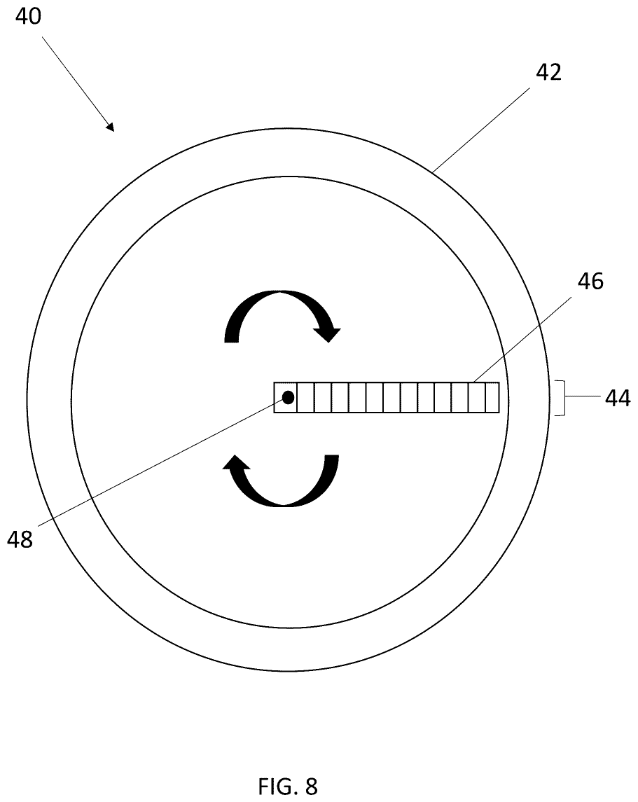

FIG. 8 illustrates a bottom view of a phased array housing device having a circular cross-section according to one embodiment of the present invention. Devices according to the present invention are not limited to those in which the linear array translates linearly. In another embodiment, for example, the phased array housing device 40 has a substantially circular cross-section. In one embodiment, a linear phased array 44, including a plurality of transducer elements 46, is attached at one end to a pivot point 48. In one embodiment, the opposite end of the linear phased array 44 is connected to a circular groove in a rim 42 of the transducer housing section of the phased array housing device 40. The linear phased array 44 is operable to pivot about the pivot point 44, such that the linear phased array 44 is able to sweep out a full rotation within the transducer housing section. One of ordinary skill in the art will understand that the present invention is not limited to devices having only a single linear phased array 44 and is able to include a plurality of linear phased arrays. In one embodiment, the plurality of linear phased arrays share a common pivot point 48.

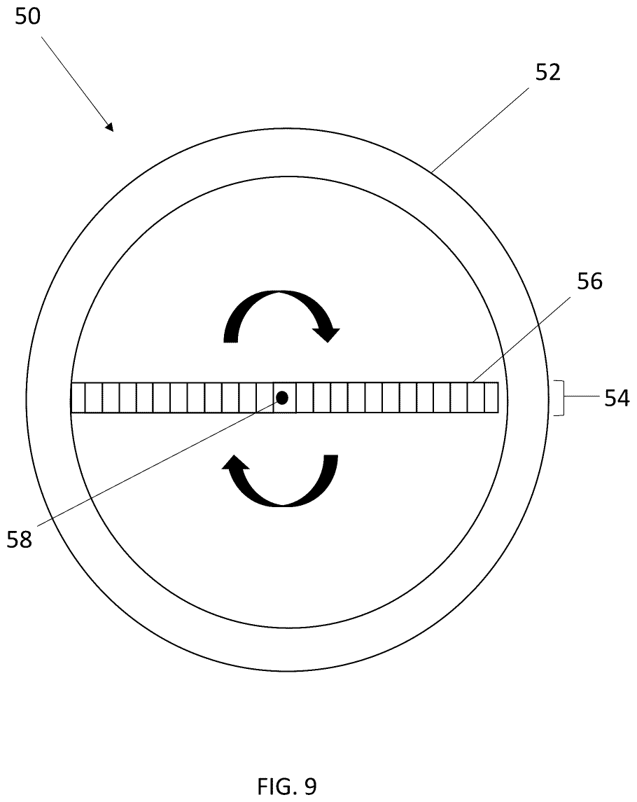

The invention is not limited to linear arrays only spanning a radius of the circular cross-section. As shown in FIG. 9, in one embodiment, a linear phased array 54, including a plurality of transducer elements 56, spans the diameter of the circular cross-section. In one embodiment, the linear phased array 54 is operable to rotate about a central pivot point 58 attached to a point proximate to the center of the linear phased array 54. In one embodiment, a first end of the linear phased array 54 is attached to a radial groove in a rim 52 of the phased array housing device 50 and a second end of the linear phased array 54 is attached to the radial groove of the rim 52 of the phased array housing device 50. In one embodiment, the linear phased array 54 is operable to complete a full 360 degree rotation within the phased array housing device 50. In another embodiment, the linear phased array 54 is only operable to complete a 180 degree rotation within the phased array housing device 50, but because the linear phased array 54 spans the diameter of the phased array housing device 50, data for a full 360 degree sweep is able to be obtained after only rotating the linear phased array 180 degrees.

In one embodiment, the phased array housing device is operable to connect via at least one wireless network (e.g., WI-FI, BLUETOOTH, etc.) to at least one user device. In another embodiment, the phased array housing device is operable to connect via a wired network to the at least one user device. User devices include, but are not limited to, smart phones, computers, tablets, smart watches, and/or other smart devices. The at least one user device is able to transmit commands to the phased array housing device in order to begin and/or end a scan. In one embodiment, the phased array housing device is operable to transmit scan data to the at least one user device and the at least one user device is able to display results of the scan data. The range of scan data able to be produced and displayed is referenced in prior art documents such as U.S. Patent Publication No. 2021/0302376, which is incorporated herein by reference in its entirety.

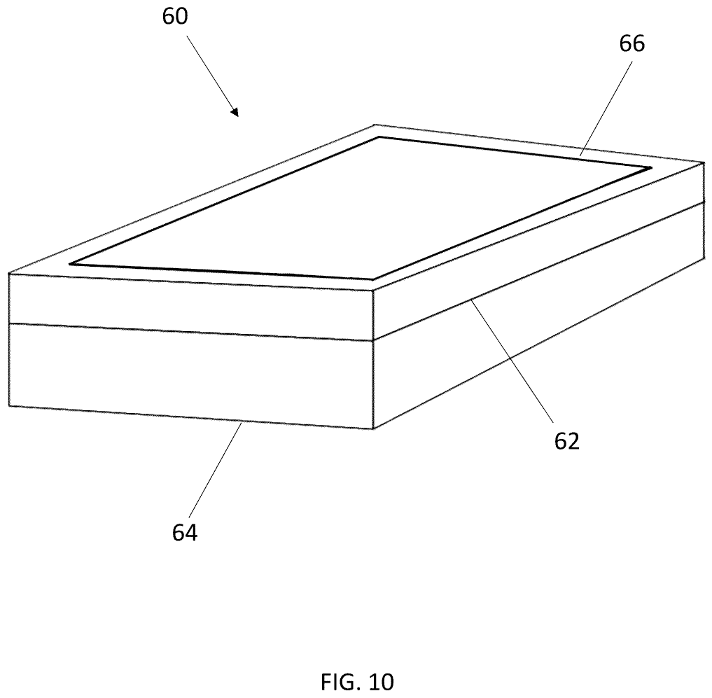

FIG. 10 illustrates a perspective view of a phased array housing device including a display screen according to one embodiment of the present invention. In one embodiment, a phased array housing device 60 includes a transducer housing section 62 and a couplant housing section 64, similar to the phased array housing device shown in FIG. 1. In one embodiment, a top surface of the transducer housing section 62 includes a display screen 66. In one embodiment, the display screen 66 shows the results of scans (e.g., C-scan images, B-scan images, etc.) performed by the phased array housing device 60. In one embodiment, the display screen 66 shows the results in real time, providing not only a visualization of defects within the test object, but also an indication for where the linear phased array is within the phased array housing device 60 at a specific time (as the scan would populate from left to right, assuming the linear phased array starts on the left side of the phased array housing device 60). Typically, just an indication is likely not noticeable, as the scan occurs within seconds. However, the real time visualization is useful in situations where the linear phased array becomes stuck, as it indicates a location beyond which the linear phased array is unable to move. In one embodiment, because the top surface is covered by the display screen 66, no handle extends from the center of the top surface of the transducer housing section 62. In one embodiment, one or more handles extend outwardly from one or more side walls of the transducer housing section 62.

In one embodiment, a power source is contained within the transducer housing section of a phased array housing device. The power source (e.g., a battery) provides power to drive motors or other means of moving the linear phased array and/or any display device attached to the phased array housing device. In one embodiment, the power source is rechargeable by plugging the phased array housing device into an external power source (e.g., a power outlet). In one embodiment, the internal power source also powers one or more pulser receiver devices for firing the phased array elements and/or any input means for commanding the firing of each phased array element, meaning that the phased array housing device does not need to plug into any external power source in order to operate. In another embodiment, the phased array housing device connects to an external power source in order to power the means of moving the linear phased array, any display device, a pulser receiver, and/or any means for commanding the phased array elements to fire.

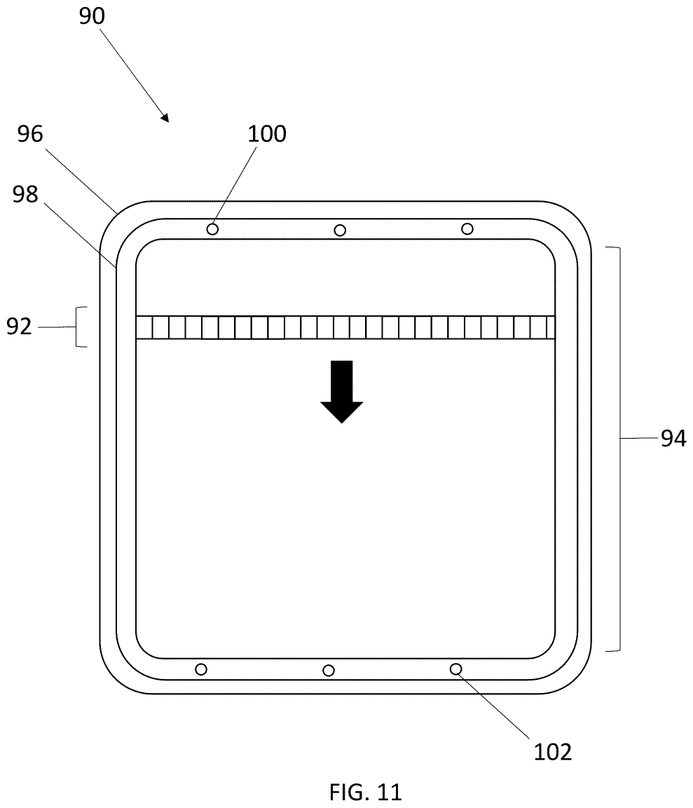

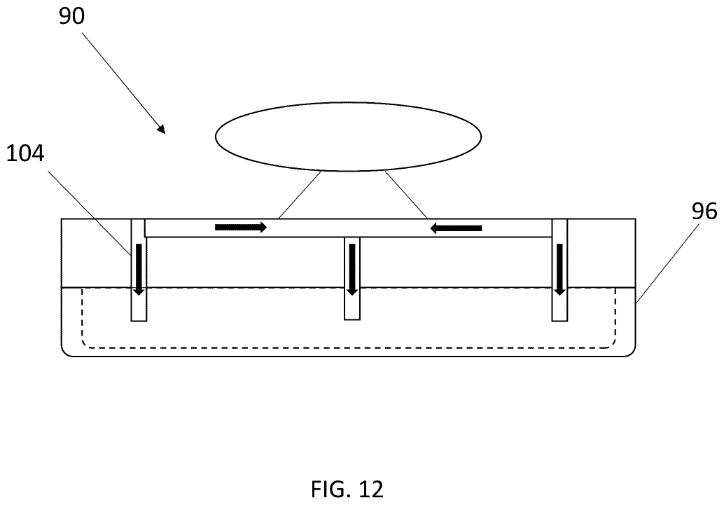

FIGS. 11-12 illustrate a phased array housing device including irrigation channels according to one embodiment of the present invention. The phased array housing device 90 includes a linear phased array 92 configured to translate across an active window 94. A rim surrounds the active window 94 of the phased array housing device 90. The rim includes an outer sealing rim 96 and an inner rim 98. The outer sealing 96 extends outwardly from the bottom of the phased array housing device 90, further outwardly than the inner rim 98. When the phased array housing device 90 is placed against a test object, the outer sealing rim 96 is pressed against the test object, sealing a small interior chamber including the inner rim 98 and a face of the active window 94.

In one embodiment, the inner rim 98 includes a plurality of irrigation outlets 100, configured to release acoustic couplant (e.g., water, acoustic gel, etc.) into the small interior chamber. The outer sealing rim 96 ensures that movement of the acoustic couplant across the surface of the test object is limited or restricted entirely. In one embodiment, the inner rim 98 further includes a plurality of suction line inlets 102. The plurality of suction line inlets 102 draw the acoustic couplant out of the small interior chamber. In one embodiment, the plurality of suction line inlets 102 on an opposite side of the inner rim 98 relative to the plurality of irrigation outlets 100. In one embodiment, the plurality of irrigation outlets 100 are placed at an angle on the inner rim 98, such that the acoustic couplant is automatically directed toward an opposite side of the inner rim 98 to be suctioned out. Including both irrigation channels 104 and suction channels allows the acoustic couplant to constantly flow across the face of the active window 94, while also allowing the phased array housing device 90 to clean up the majority of the acoustic couplant after use. The irrigation channels 104 and the suction channels extend through outer edges of the phased array housing device 90 and connect to at least one acoustic couplant pump and at least one vacuum pump respectively.

One of ordinary skill in the art will understand that the phased array housing device according to the present invention is capable of detecting defects or features capable of being detected by prior art phased array systems, including, by way of example and not limitation, foreign objects, bondline defects, impact damage, wrinkles, delaminations, and/or any other type of feature.

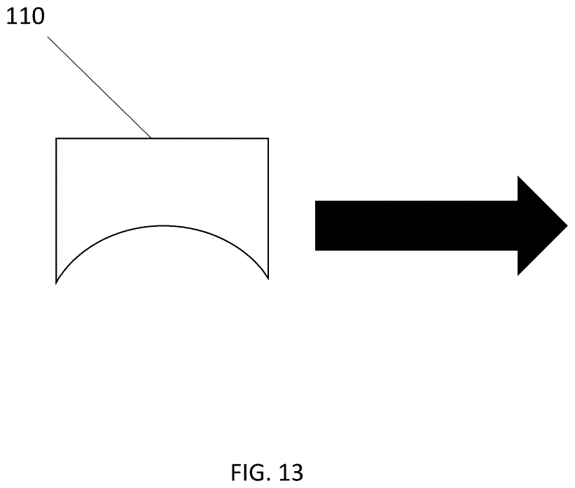

FIG. 13 illustrates an ultrasonic element according to one embodiment of the present invention. In one embodiment, the linear phased array include one or more specifically focused transducer elements 110. Specifically focused transducer elements 110 are those having curvature such that each specifically focused transducer element is focused on a specific point. In one embodiment, as shown in FIG. 13, the one or more specifically focused transducer elements 110 are focused along the passive axis. By having the geometry of the transducer elements focus in the passive direction and focal laws focus in the active direction, the system is able to achieve improved resolution and precision. For the purposes of the present application, the passive axis refers to the axis parallel to the direction of movement of the linear array. The active axis is orthogonal to the passive axis and therefore parallel to the linear array itself.

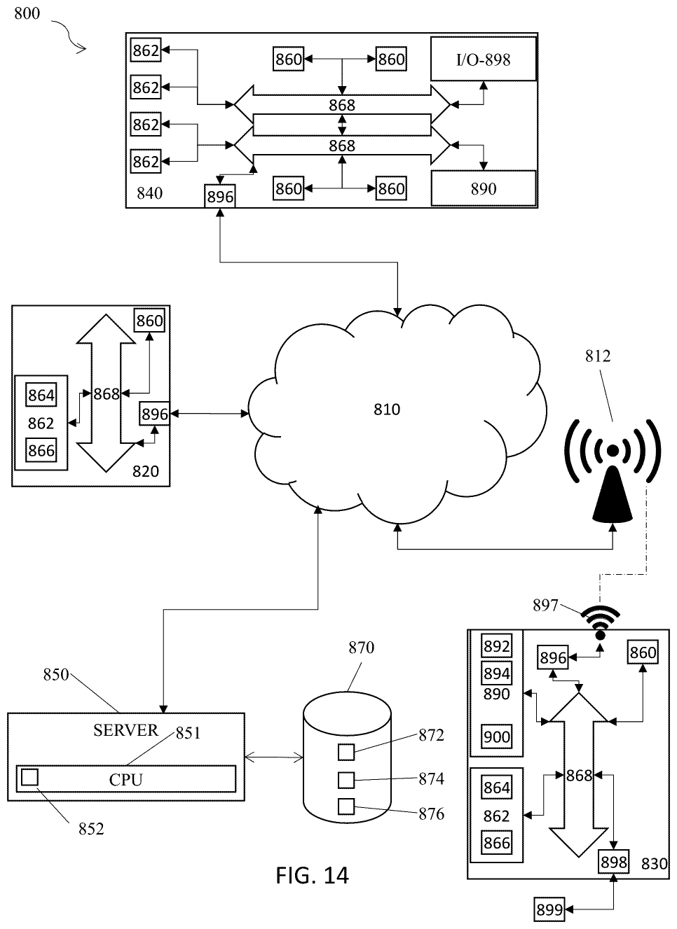

FIG. 14 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 14, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 14, is operable to include other components that are not explicitly shown in FIG. 14, or is operable to utilize an architecture completely different than that shown in FIG. 14. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A phased array scanning device, comprising:
a frame including a top base and side walls extending downwardly from edges of the top base;
at least one deformable bladder stretched between bottom ends of the side walls, such that the at least one deformable bladder, the top base, and the side walls define an interior chamber;
at least one linear array of ultrasonic transducers within the interior chamber; and
at least one motor operable to translate the at least one linear array across the length and/or width of the interior chamber;
wherein the interior chamber or a section of the interior chamber includes at least one coupling substance.

2. The phased array scanning device of claim 1, further including at least one pump configured to pump in the at least one coupling substance into the interior chamber or the section of the interior chamber.

3. The phased array scanning device of claim 1, wherein the bottom ends of the side walls of the frame include at least one suction cup and/or at least one magnet.

4. The phased array scanning device of claim 1, wherein at least one handle extends upwardly from the top base of the frame.

5. The phased array scanning device of claim 1, wherein interior surfaces of the side walls of the frame include linear grooves, and wherein edges of the at least one linear array are configured to fit within and move through the linear grooves.

6. The phased array scanning device of claim 1, wherein the at least one linear array includes a plurality of linear arrays of ultrasonic transducers.

7. The phased array scanning device of claim 1, wherein the coupling substances includes water, an acoustic gel, and/or one or more polymer blocks.

8. The phased array scanning device of claim 1, wherein the side walls of the frame include one or more recesses, and wherein the at least one linear array is configured to fit within the one or more recesses before and/or after performing a full scan.

9. A method for performing non-destructive testing, comprising:
providing a frame including a top base and side walls extending downwardly from edges of the top base and having at least one deformable bladder stretched between bottom ends of the side walls, such that the at least one deformable bladder, the top base, and the side walls define an interior chamber;
at least one motor translating at least one linear array of ultrasonic transducers within the interior chamber across the length and/or width of the interior chamber; and
one or more pulser receivers individually firing each transducer in the at least one linear array of ultrasonic transducers according to a predetermined pattern.

10. The method of claim 9, the at least one linear array translates across the full length and/or width of the interior chamber within approximately 2-5 seconds.

11. The method of claim 9, further comprising attaching the frame to a test object to be scanned via one or more suction cups and/or magnets connected to the frame.

12. The method of claim 9, further comprising the at least one linear array moving out of at least one recess in the frame to begin and moving back within the at least one recess in the frame to end the scan.

13. The method of claim 9, further comprising filling the interior chamber with at least one coupling substance.

14. The method of claim 13, wherein the filling of the interior chamber is done by at least one pump connected to the interior chamber.

15. The method of claim 9, wherein interior surfaces of the side walls of the frame include linear grooves, and wherein edges of the at least one linear array are configured to fit within and move through the linear grooves.

16. The method of claim 9, wherein at least one handle extends upwardly from the top base of the frame.

17. A phased array scanning device, comprising:
a frame including a top base and side walls extending downwardly from edges of the top base;
at least one deformable bladder stretched between bottom ends of the side walls, such that the at least one deformable bladder, the top base, and the side walls define an interior chamber;
at least one linear array of scanning elements within the interior chamber; and
at least one motor operable to translate the at least one linear array across the length and/or width of the interior chamber;
wherein the at least one linear array is operable to pivot at one end of the linear array, such that the at least one linear array is able to rotate by approximately 90 degrees.

18. The phased array scanning device of claim 17, wherein the at least one linear array includes a plurality of linear arrays of ultrasonic transducers.

19. The phased array scanning device of claim 17, wherein the side walls of the frame include one or more recesses, and wherein the at least one linear array is configured to fit within the one or more recesses before and/or after performing a full scan.

20. The phased array scanning device of claim 17, wherein interior surfaces of the side walls of the frame include linear grooves, and wherein edges of the at least one linear array are configured to fit within and move through the linear grooves.
